(19) United States
(12) Patent Application Publication
(10) Pub. No.: US 2025/0168704 A1
(43) Pub. Date: May 22, 2025

(54) SYSTEMS AND METHODS FOR SUPPORTING MULTIPLE UNIVERSAL SUBSCRIBER IDENTITY MODULES GAP

(71) Applicant: Telefonaktiebolaget LM Ericsson (PUBL), Stockholm (SE)

(72) Inventors: Nianshan Shi, JÄRFÄLLA (SE); Lian Araujo, SOLNA (SE)

(21) Appl. No.: 18/839,488

(22) PCT Filed: Feb. 22, 2023
(86) PCT No.: PCT/IB2023/051623

§ 371 Date: Aug. 19, 2024

Related U.S. Application Data
(60) Provisional application No. 63/313,695, filed on Feb. 24, 2022.

(51) Int. Cl. H04W 28/18; H04W 8/18

(52) U.S. Cl. CPC H04W 28/18; H04W 8/18

(57) ABSTRACT

A method (700) performed by a first network node (1100, 910) operating as a Centralized Unit, CU, includes determining (702) at least one selected gap configuration by the first network node operating as the CU. The first network node sends (704), to a second network node (1100, 910) operating as a Distributed Unit, DU, the at least one selected gap configuration. The at least one selected gap configuration is selected for maintaining a first connection between a user equipment, UE (1000, 912), and a first network associated with a first subscriber identity of the UE while the UE performs actions on a second network associated with a second subscriber identity of the UE.

### TECHNICAL FIELD

The present disclosure relates, in general, to wireless communications and, more particularly, systems and methods for Multiple Universal Subscriber Identity Modules (MUSLIM) gap.

### BACKGROUND

The third generation partnership project (3GPP) is currently studying in Release 17 (Rel-17) how to best support a user equipment (UE) that can manage two or more simultaneous subscriptions (also called Multi-USIM or MUSIM, where USIM refers to a Universal Subscriber Identity Module). A single UE is capable of having two or more subscription credentials and basically to “act” as two UEs within one device/hardware entity. Even though mobile terminals with that capability exist, most operations are not really optimized as there is no specific standardized support for MUSIM in order to make it easier for UEs to manage two or more subscriptions simultaneously.

Several aspects may be addressed. For example, a UE may need to be provided support to easily switch between states related to utilization or communication using a first subscription and states related to utilization or communication using a second subscription. As an example, the first subscription (subscription 1 or USIM1) may connect to a first public land mobile network (PLMN1) and the second subscription (subscription 2 or USIM2) may connect to a second PLMN (PLMN2). States related to utilization or communication using either subscription 1 or subscription 2 may be dependent on factors such as whether radio resource control (RRC) connected (RRC_CONNECTED) has been established in PLMN1 and/or PLMN2. Such switching may be straightforward, or maybe not even necessary, if the UE has the capability of communicating simultaneously towards two networks, using USIM1 and USIM2 simultaneously. For this to work, there may be a need for at least dual receiver and transmitter chains so that frequencies that are used towards both networks do not cause interference to each other and so that radio separation is good enough to not cause intermodulation (IM) effects in the device. Yet, other aspects that can be addressed is to introduce standardized signaling that allows a UE that cannot simultaneously communicate with two or more networks to at least signal a network that it is leaving, or becoming unreachable for that network.

The Rel-17 work on MUSIM includes the following objectives:
Objective 1: Specify, if necessary, enhancement(s) to address the collision due to reception of paging when the UE is in RRC_IDLE/RRC_INACTIVE mode in both the networks associated with respective Subscriber Identity Modules (SIMs):
   Radio Access Technology (RAT) Concurrency: Network A can be New Radio (NR) or Long Term Evolution (LTE). Network B can either be LTE or NR.
   Applicable UE architecture: Single-Rx/Single-Tx (where Rx refers to reception and Tx refers to transmission).
Objective 2: Specify mechanism for UE to notify Network A of its switch from Network A (for MUSIM purpose):
   RAT Concurrency: Network A is NR. Network B can either be LTE or NR.
   Applicable UE architecture: Single-Rx/Single-Tx, Dual-Rx/Single-Tx
Objective 3: Unless 3GPP System Aspects (SA) Working Group (WG) 2 (SA2) finds an alternative solution or decides otherwise, specify mechanism for an incoming page to indicate to the UE whether the service is Voice-over-LTE (VoLTE) or Voice-over-NR (VoNR).
   RAT Concurrency: Network A is either LTE or NR. Network B is either LTE or NR.
   Applicable UE architecture: Single-Rx/Dual-Rx/Single-Tx

Certain of these objectives are being worked on by 3GPP Radio Access Network (RAN) WG2 (RAN2), for example. As part of Objective 2 above, a MUSIM gap framework is introduced over RRC. This framework allows the UE to provide UE assistance information (UAI) to the network on preferred gaps. During a gap, the UE can temporarily perform actions on another network while still in RRC_CONNECTED mode to its current network. The UAI for MUSIM gaps are described in RRC as follows:

```
MUSIM-Assistance-r17 ::=  SEQUENCE {
    musim-PreferredRRC-State-r17  ENUMERATED {IDLE, INACTIVE}
OPTIONAL,
    musim-GapPreferenceList-r17  OPTIONAL,
  . . .
}
MUSIM-GapPreferenceList-r17 ::= SEQUENCE (SIZE (1..3)) OF MUSIM-GapInfo-r17
MUSIM-GapInfo-r17 ::=  SEQUENCE {
  musim-Starting-SFN-AndSubframe-r17  OPTIONAL,
  musim-GapLength-r17  ENUMERATED {ms4, ms5dot5, ms6, ms10, ms20},
musim-GapRepetition AndOffset-r17  CHOICE {
```

| | |
|---|---|
| ms20-r17 | INTEGER (0..19), |
| ms40-r17 | INTEGER (0..39), |
| ms80-r17 | INTEGER (0..79), |
| ms160-r17 | INTEGER (0..159), |
| ms320-r17 | INTEGER (0..319), |
| ms640-r17 | INTEGER (0..639), |
| ms 1280-r17 | INTEGER (0..1279), |
| ms2560-r17 | INTEGER (0..2559), |
| . . . | |

```
}  OPTIONAL -- Cond periodic
}
MUSIM-Starting-SFN-AndSubframe-r17 ::=  SEQUENCE {
  starting-SFN-r17  INTEGER (0..1023),
  startingSubframe-r17  INTEGER (0..9)
}
```

The network then may configure the UE with the MUSIM gap preference (gap length, periodicity, starting point) indicated by the UE:

```
MUSIM-GapConfig-r17 ::=  SEQUENCE {
    musim-gapUE-r17  SetupRelease {MUSIM-GapConfig-r17}
OPTIONAL -- Need M
}
MUSIM-GapConfig-r17 ::=  SEQUENCE {
      musim-GapToReleaseList-r17  SEQUENCE (SIZE (1..3)) OF MUSIM-GapIndex-Id-
r17 OPTIONAL,
      musim-GapToAddModList-r17  MUSIM-GapToAddModList-r17
OPTIONAL,
  . . .
}
MUSIM-GapToAddModList-r17 ::= SEQUENCE (SIZE (1..3)) OF MUSIM-GapInfo-r17
MUSIM-GapInfo-r17 ::=  SEQUENCE {
    musim-GapIndex-Id-r17  INTEGER (0..2),
    musim-Starting-SFN-AndSubframe-r17  MUSIM-Starting-SFN-AndSubframe-r17
OPTIONAL, -- Cond aperiodic
    musim-GapLength-r17  ENUMERATED {ms4, ms5dot5, ms6, ms10, ms20}
OPTIONAL,
musim-GapRepetition AndOffset-r17  CHOICE {
```

| | |
|---|---|
| ms20-r17 | INTEGER (0..19), |
| ms40-r17 | INTEGER (0..39), |
| ms80-r17 | INTEGER (0..79), |
| ms160-r17 | INTEGER (0..159), |
| ms320-r17 | INTEGER (0..319), |
| ms640-r17 | INTEGER (0..639), |
| ms1280-r17 | INTEGER (0..1279), |
| ms2560-r17 | INTEGER (0..2559), |

```
      . . .
}  OPTIONAL -- Cond periodic
}
MUSIM-Starting-SFN-AndSubframe-r17 ::=  SEQUENCE {
  starting-SFN-r17  INTEGER (0..1023),
  starting Subframe-r17  INTEGER (0..9)
}
```

There currently exist certain challenge(s). For example, in the split Next Generation-Radio Access Network (NG-RAN) architecture and when dual-connectivity (DC) is used, there is no specification to specify how MUSIM gap is conveyed between the related nodes. For the DC case, this may result in secondary node (SN) transmissions while the UE may be listening to another network.

### SUMMARY

Certain aspects of the disclosure and their embodiments may provide solutions to these or other challenges. For example, systems and methods are disclosed for supporting MUSLIM gap.

According to certain embodiments, a method by a first network node operating as a CU includes determining at least one selected gap configuration by the first network node operating as the CU. The first network node sends, to a second network node operating as a DU, the at least one selected gap configuration. The at least one selected gap configuration is selected for maintaining a first connection between a UE and a first network associated with a first subscriber identity of the UE while the UE performs actions on a second network associated with a second subscriber identity of the UE.

According to certain embodiments, a first network node operating as a CU is adapted to determine at least one selected gap configuration by the first network node operating as the CU. The first network node is adapted to send, to a second network node operating as a DU, the at least one selected gap configuration. The at least one selected gap configuration is selected for maintaining a first connection between a UE and a first network associated with a first subscriber identity of the UE while the UE performs actions on a second network associated with a second subscriber identity of the UE.

According to certain embodiments, a method by a second network node operating as a DU includes receiving, from a first network node operating as a CU, at least one selected gap configuration. The at least one selected gap configuration is selected for maintaining a first connection between a UE and a first network associated with a first subscriber identity of the UE while the UE performs actions on a second network associated with a second subscriber identity of the UE. The second network node performs one of: using the at least one selected gap configuration from the first network node operating as the CU; and transmitting, to the first network node operating as the CU, a final preferred gap configuration.

According to certain embodiments, a second network node operating as a DU is adapted to receive, from a first network node operating as a CU, at least one selected gap configuration. The at least one selected gap configuration is selected for maintaining a first connection between a UE and a first network associated with a first subscriber identity of the UE while the UE performs actions on a second network associated with a second subscriber identity of the UE. The second network node is adapted to perform one of: using the at least one selected gap configuration from the first network node operating as the CU; and transmitting, to the first network node operating as the CU, a final preferred gap configuration.

Certain embodiments may provide one or more of the following technical advantage(s). For example, in the case that the MUSIM gap is not to be modified by the gNodeB-Distributed Unit (gNB-DU), it is provided from the gNodeB-Centralized Unit (gNB-CU) to the gNB-DU. Conversely, in the case that the gNB-CU wants the gNB-DU to be involved in determining the MUSIM gap, the gNB-CU will send a request to the gNB-DU to determine the MUSIM gap, as well as the preferred MUSIM gap of the UE.

Other advantages may be readily apparent to one having skill in the art. Certain embodiments may have none, some, or all of the recited advantages.

### BRIEF DESCRIPTION OF THE DRAWINGS

FIG. 1 illustrates an example of a message flow diagram where a gNB-CU determines the final MUSIM Gap, according to certain embodiments;

FIG. 2 illustrates an example of a message flow diagram where a gNB-CU allows a gNB-DU to make the final decision of the MUSIM Gap, according to certain embodiments;

FIG. 3 illustrates an example of a message flow diagram when DC is involved, according to certain embodiments;

FIG. 4 illustrates an example method performed by a wireless device, in according to certain embodiments;

FIG. 5 illustrates another example method performed by a wireless device, according to certain embodiments;

FIG. 6 illustrates an example method performed by a network node, according to certain embodiments;

FIG. 7 illustrates an example method performed by a network node operating as a CU, according to certain embodiments;

FIG. 8 illustrates an example method performed by a network node operating as a DU, according to certain embodiments;

FIG. 9 illustrates an example of a communication system, according to certain embodiments;

FIG. 10 illustrates a UE, according to certain embodiments;

FIG. 11 illustrates a network node, according to certain embodiments;

FIG. 12 illustrates a block diagram of a host, according to certain embodiments;

FIG. 13 illustrates a block diagram of a virtualization environment, according to certain embodiments; and

FIG. 14 illustrates a communication diagram of a host communicating via a network node with a UE over a partially wireless connection, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

In the embodiments described below, “MUSIM gap” may refer to any of:
The UAI containing preference for MUSIM gaps that the network received from the UE;
Specific field(s) from the UAI containing preference for MUSIM gaps that the network received from the UE; or
New field(s) defined for gNB-CU and/or gNB-DU (or for MN and/or SN) that may contain any of gap length, periodicity, starting point, or offset, or other fields that are also present within an UAI containing preference for MUSIM gaps.

Certain embodiments describe triggering network actions when the preferred MUSIM gap is received from UE. However, the embodiments described herein also apply to the case where one of the nodes (such as gNB-CU, gNB-DU, Master Node (MN), or Secondary Node (SN)) needs to trigger a renegotiation of the MUSIM gaps. For example, one of the nodes may trigger a renegotiation of the MUSIM gaps if scheduling conditions or requirements have changed for one of the nodes.

Embodiments described for a particular node can also be applicable to other nodes. As an example, certain embodiments describe a gNB-CU that selects a MUSIM gap based on a configuration and policy. As another alternative, the gNB-DU could also do such determination (e.g., in certain embodiments, the gNB-DU selects a MUSIM gap based on a configuration and policy).

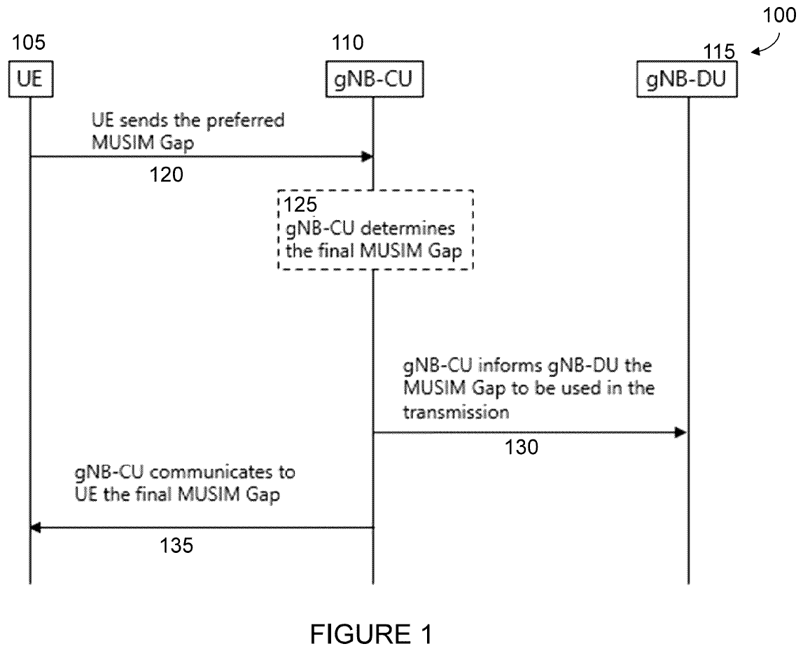

FIG. 1 illustrate a message flow diagram 100 where a gNB-CU determines the final MUSIM Gap, in accordance with certain embodiments. Specifically, FIG. 1 shows the steps and signaling exchanged between a UE 105, a gNB-CU 110, and a gNB-DU 115 during an example scenario in which the gNB-CU determines the final MUSIM Gap.

For example, at 120, a UE 105 sends a gNB-CU 110 a preferred MUSIM gap of the UE 105. When the gNB-CU 110 receives the preferred MUSIM gap from the UE 105, the gNB-CU 110 determines/selects the (final) MUSIM gap, at 125. According to various particular embodiments, the gNB-CU 110 may determine the MUSIM gap based on a configuration, a policy, and the UE-supported gap patterns. As an example, the gNB-CU 110 may select the UE's preferred MUSIM gap or a different MUSIM gap supported by the UE 105 depending on the configuration and/or policy.

At 130, the gNB-CU 110 sends, to the gNB-DU 115 the chosen MUSIM Gap. The gNB-CU 110 also configures/confirms the selected MUSIM gap to the UE 105, at 135. Communication from the gNB-CU 110 to the gNB-DU 115 and to the UE 105 can be performed in parallel (e.g., the gNB-CU 110 can communicate with the gNB-DU 115 and the UE 105 at the same time or during an overlapping time period) or in serial, depending on the embodiment.

In certain embodiments such as, for example, a DC case, an MN conveys the MUSIM gap from MN to SN. In this scenario, the MN has RRC connection and connection to CN at the control plane. Both MN and SN are NG-RAN node, which could contain gNB-CU and gNB-DU. Thus, in the DC scenario, MN receives the preferred MUSIM gap, gNB-CU in MN sends it to gNB-CU in the SN, and the gNB-CU in the SN sends it to the gNB-DU in SN.

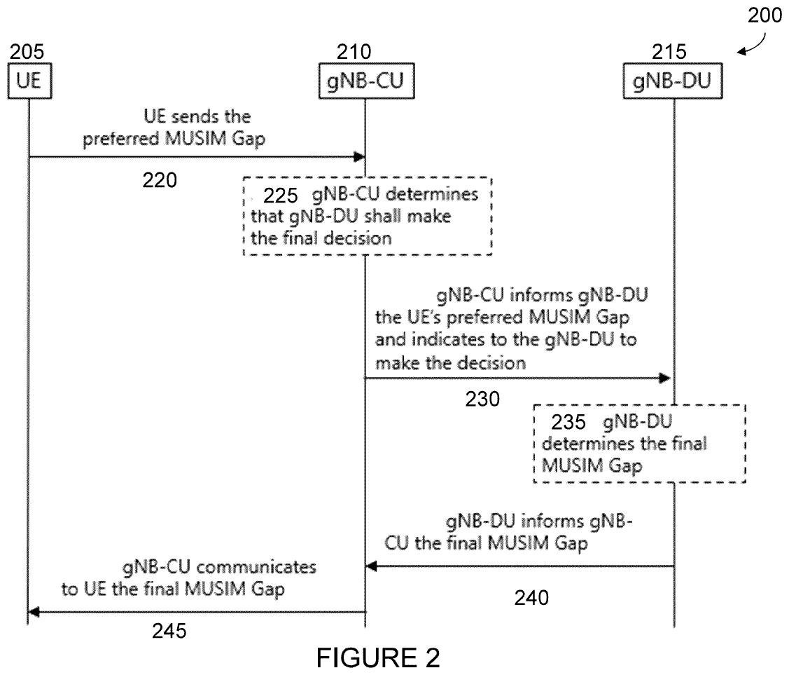

According to certain other embodiments, the gNB-DU may select the MUSIM gap based on a configuration and policy. For example, FIG. 2 illustrates an example message flow diagram 200 where a gNB-CU allows a gNB-DU to make the final decision of the MUSIM Gap, in accordance with certain embodiments. Specifically, FIG. 2 shows the steps and signaling exchanged between a UE 205, a gNB-CU 210, and a gNB-DU 215 during an example scenario in which the gNB-DU determines the final MUSIM Gap.

At 220, a UE 205 sends a gNB-CU 210 a preferred MUSIM gap of the UE 205. When the gNB-CU 210 receives the preferred MUSIM gap from the UE 205, the gNB-CU 210 determines, at 225, to let the gNB-DU 215 determine the final MUSIM gap. For example, the gNB-CU 210 may determine, based on a configuration and/or policy, whether the gNB-CU 210 or the gNB-DU 215 should select the final MUSIM gap. In response to determining that the gNB-DU 215 should select the final MUSIM gap, the gNB-CU 210 sends the gNB-DU 215 the preferred UE MUSIM Gap (e.g., the preferred MUSIM gap that the gNB-CU 210 previously received from the UE 205) and/or a list of the supported MUSIM Gaps, at 230. The gNB-CU 210 also sends the gNB-DU 215 an indication that gNB-DU 215 should make the final decision. The indication may be sent in the same message or a different message. Further, in certain embodiments, the gNB-CU 210 may indicate to the gNB-DU 215 if the UE 205 supports the Gap patterns out of the list. This indication may be included in the message sent at 230 or in another message. When the gNB-DU 215 has made the final decision as to the MUSIM gap, the gNB-DU 215 may send the MUSIM gap to the gNB-CU, at 240. The gNB-CU 210 may then, in turn, send the MUSIM gap to the UE 205. The gNB-DU will use the chosen MUSIM gap in the transmission.

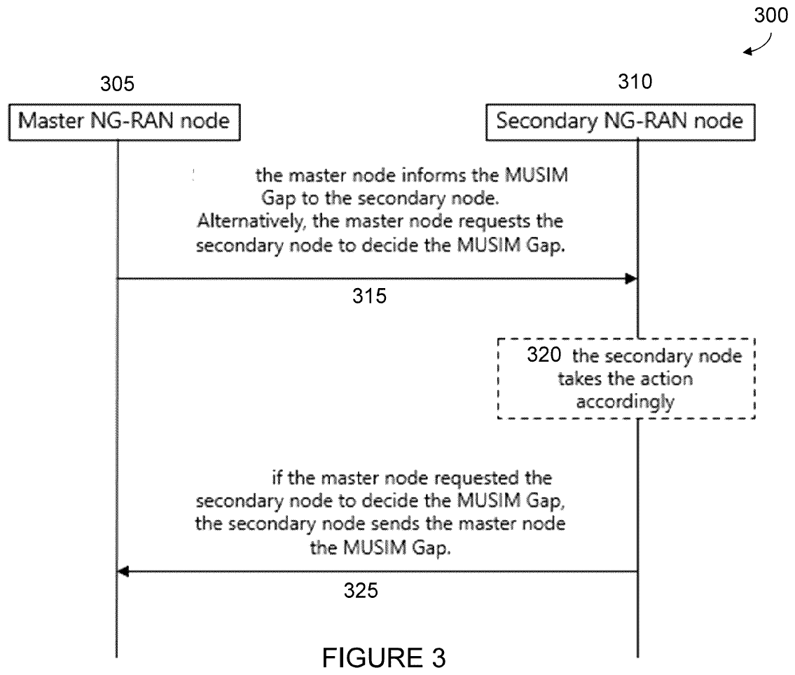

FIG. 3 illustrates an example for the case of DC, according to certain embodiments. Specifically, FIG. 3 shows the steps and signaling exchanged between a Master MG-RAN node (MN) 305 and a Secondary NG-RAN node (SN) 310. For example, at 315, the MN 305 informs the SN 310 of the MUSIM Gap. Alternatively, the MN 305 requests the SN 310 to decide the MUSIM Gap.

At 320, the SN 310 takes action accordingly (e.g., uses the MUSIM Gap provided by the MN 305 or decides the MUSIM Gap if requested by the MN 305). At 325, if the MN 305 requested the SN 310 to decide the MUSIM Gap, the SN 310 sends the MN 305 the MUSIM Gap.

Protocol wise, certain embodiments could be implemented so that the gNB-CU sends the gNB-DU the MUSIM Gap and an Indication to indicate when the gNB-CU requests the gNB-DU to make the final decision. If such Indication is included, the gNB-DU would decide the MUSIM Gap based on its local information. The gNB-DU would then convey the final decision back to gNB-CU. Alternatively, if such Indication is not included, the gNB-DU would just take the signaled MUSIM Gap and use it. Thus, the gNB-DU may receive from the gNB-CU information associated with configuring the MUSIM Gap, determine whether the information indicates that the gNB-DU is to make the final MUSIM Gap decision, and either use a MUSIM Gap received in the information from the gNB-CU or decide the final MUSIM Gap depending on whether the information indicates that the gNB-DU is to make the final MUSIM Gap decision. If the gNB-DU is to make the final MUSIM Gap decision, the gNB-DU may decide to use a MUSIM Gap indicated by the gNB-CU (such as the UE's preferred MUSIM Gap) or a different MUSIM Gap (such as another MUSIM Gap supported by the UE). The decision may be based on a configuration and/or policy, for example.

Alternatively, gNB-CU indicates gNB-DU not to be involved in the MUSIM Gap decision making, and only use the MUSIM gap received.

Table 1 illustrates an example modification of 3GPP Technical Specification (TS) 38.472 Section 9.3.1.25 (CU to DU RRC Information) for the gNB-CU to signal to the gNB-DU the MUSIM Gap and the indicator when the gNB-CU requests the gNB-DU to determine the MUSIM Gap. This Information Element (IE) contains RRC Information sent from the gNB-CU to the gNB-DU.

TABLE 1

| IE/Group | | | IE type and | | | Assigned |
|---|---|---|---|---|---|---|
| Name | Presence | Range | reference | Semantics description | Criticality | Criticality |
| CG- | O | | OCTET | CG-ConfigInfo, as | — | |
| ConfigInfo | | | STRING | defined in TS 38.331. | | |

Unchanged IEs skipped

| | | | | | |
|---|---|---|---|---|---|
| MUSIM Gap | O | OCTET | MUSIM Gap, as | Yes | ignore |
| Information | | STRING | defined in TS 38.331. | | |
| MUSIM Gap | O | ENUMERATED | Value “requested” | Yes | ignore |
| Request | | (requested, . . . ) | means that gNB-CU | | |
| Indicator | | | requests gNB-DU to | | |
| | | | determine the MUSIM | | |
| | | | Gap. | | |

Table 2 illustrates an example modification of 3GPP TS 38.472 Section 9.3.1.25 (CU to DU RRC Information) for the gNB-CU to signal to the gNB-DU the MUSIM Gap and the indicator when the gNB-CU does not request the gNB-DU to determine the MUSIM Gap. This Information Element (IE) contains RRC Information sent from the gNB-CU to the gNB-DU.

TABLE 2

| IE/Group | | | IE type and | | | Assigned |
|---|---|---|---|---|---|---|
| Name | Presence | Range | reference | Semantics description | Criticality | Criticality |
| CG- | O | | OCTET | CG-ConfigInfo, as | — | |
| ConfigInfo | | | STRING | defined in TS 38.331. | | |

Unchanged IEs skipped

| | | | | | |
|---|---|---|---|---|---|
| MUSIM Gap | O | OCTET | MUSIM Gap, as | Yes | ignore |
| Information | | STRING | defined in TS 38.331. | | |
| MUSIM Gap | O | ENUMERATED | Value “not-requested” | Yes | ignore |
| Request | | ( . . . , not- | means that gNB-CU | | |
| | | requested | does not request gNB- | | |
| | | | DU to decide on | | |
| | | | MUSIM Gap. | | |

According to certain embodiments that may be employed concurrently with or independently of any of the embodiments described above, a UE sends a gNB-CU a preferred MUSIM gap of the UE. When the gNB-CU receives the preferred MUSIM gap from the UE, the gNB-CU determines, based on the configuration and policy, its own restrictions for MUSIM gap. Examples of restrictions may include which gap length and offset values are preferred by the gNB-CU. According to certain embodiments, the gNB-CU will send those restrictions to gNB-DU. The gNB-DU can then return to the gNB-CU the MUSIM gap that accounts for restrictions on both the gNB-DU and the gNB-CU. The gNB-CU can then configure/confirm the decided MUSIM gap to UE. The exchange of restrictions between the nodes can be defined as a single entry for each information contained in MUSIM gap or a list of restrictions.

In the DC case, the MN will convey the restrictions to the SN. The SN can send to the MN a MUSIM gap accounting for restrictions on both the MN and the SN.

According to certain other embodiments, when the preferred MUSIM gap is received from the UE, in the DC case, the MN can also trigger the release of the SN.

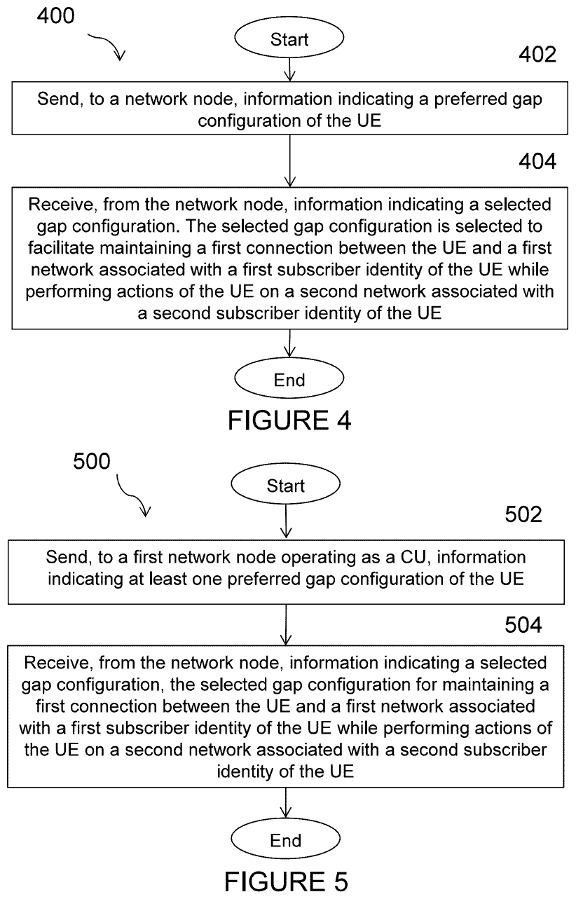

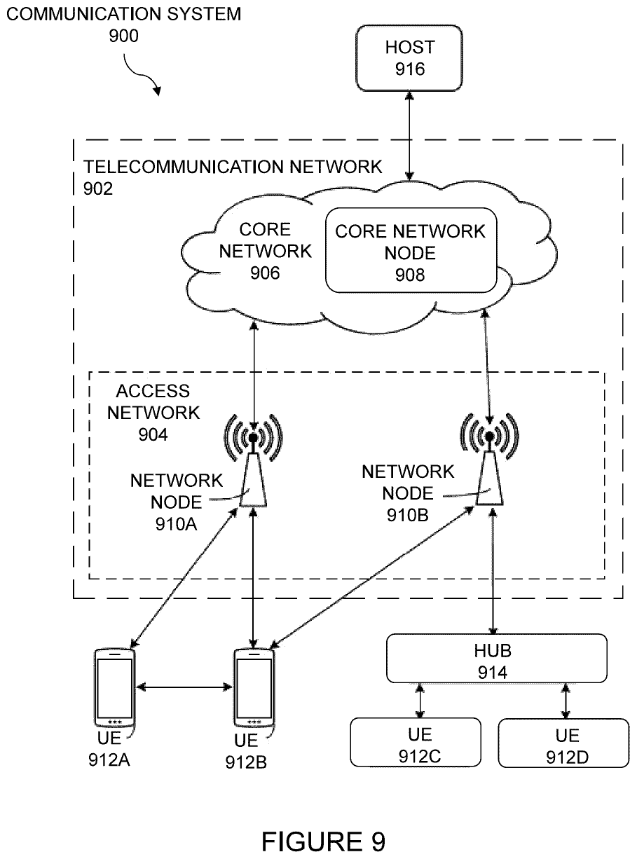

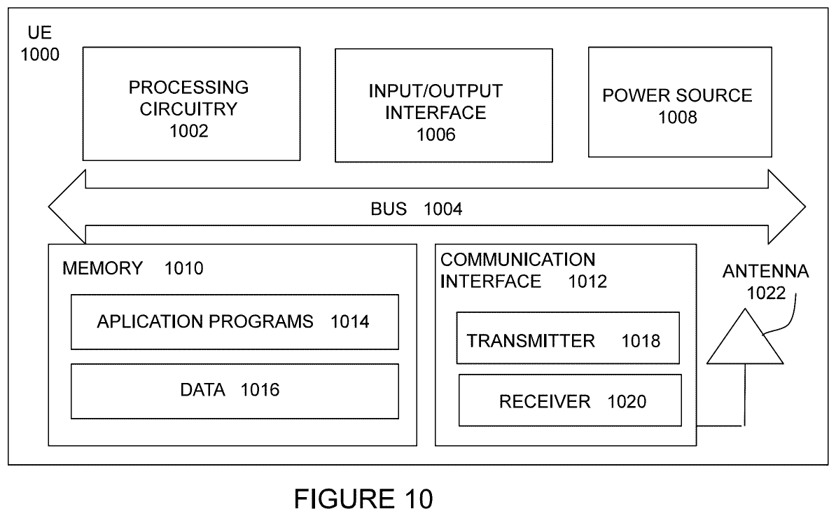

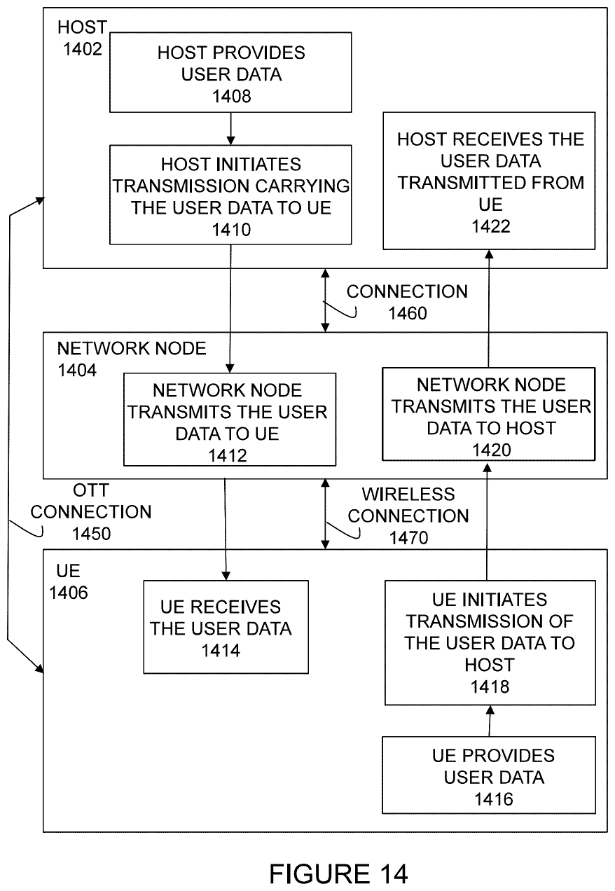

FIG. 4 illustrates an example of a method 400 performed by a wireless device, in accordance with certain embodiments. Examples of a wireless device are described above (such as the UE of FIG. 1 or FIG. 2) and below (such as UE 912 of FIG. 9, UE1000 of FIG. 10, or UE 606 of FIG. 14). For example, in certain embodiments, the wireless device includes a UE that comprises processing circuitry configured to perform any of the steps of the method shown in FIG. 4.

In the illustrated method 400, the UE may be configured to support multiple subscriptions (e.g., the UE may support MUSIM). The method begins at step 402 when the UE sends, to a network node, information indicating a preferred gap configuration of the UE. The method proceeds to step 404 with the UE receiving, from the network node, information indicating a selected gap configuration. The selected gap configuration is selected to facilitate maintaining a first connection between the UE and a first network associated with a first subscriber identity of the UE while performing actions of the UE on a second network associated with a second subscriber identity of the UE. In certain embodiments, the UE may store the selected gap configuration and/or use the selected gap configuration to facilitate MUSIM operation. Further examples of steps that may be performed by the UE as described above with regard to FIGS. 1-3 and below with regard to FIG. 5.

FIG. 5 illustrates another example of a method 500 performed by a wireless device, in accordance with certain embodiments. Examples of a wireless device are described above (such as the UE of FIG. 1 or FIG. 2) and below (such as UE 912 of FIG. 9, UE1000 of FIG. 10, or UE 606 of FIG. 14). For example, in certain embodiments, the wireless device includes a UE that comprises processing circuitry configured to perform any of the steps of the method shown in FIG. 5.

In the illustrated method 500, the UE may be configured to support multiple subscriptions (e.g., the UE may support MUSIM). The method begins at step 502 when the UE sends, sends, to a first network node operating as a CU, information indicating at least one preferred gap configuration of the UE. At step 504, the UE receives, from the network node, information indicating a selected gap configuration. The selected gap configuration is for maintaining a first connection between the UE and a first network associated with a first subscriber identity of the UE while performing actions of the UE on a second network associated with a second subscriber identity of the UE.

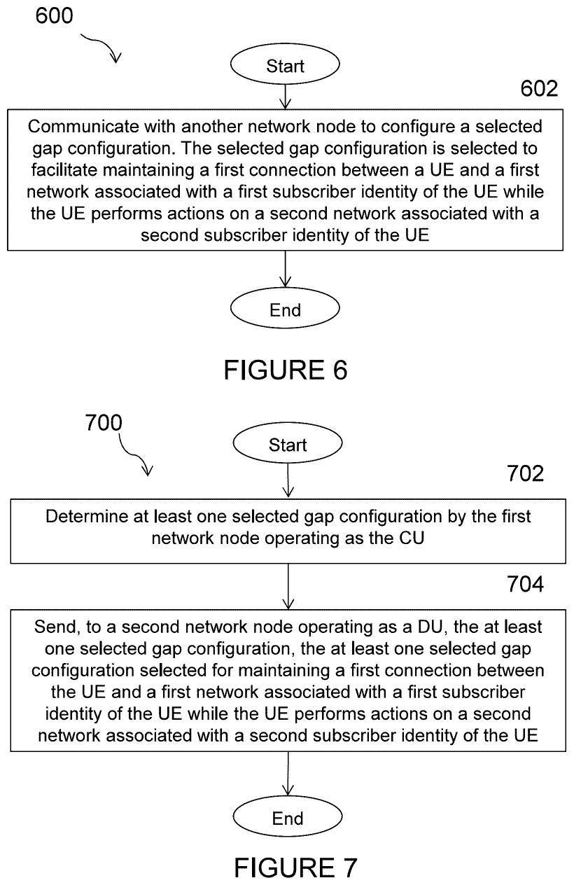

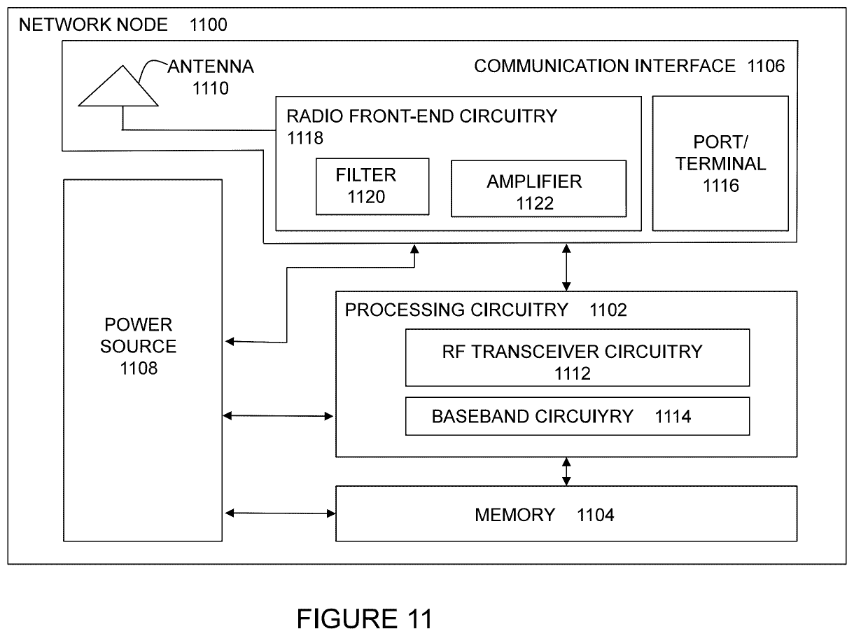

FIG. 6 illustrates an example method 600 performed by a network node, according to certain embodiments. Examples of a network node are described above (such as the gNB-CU, gNB-DU, MN, or SN described with respect to FIGS. 1-3) and below (such as network node 910 of FIG. 9, network node 1100 of FIG. 11, or network node 604 of FIG. 14). For example, in certain embodiments, the network node comprises processing circuitry configured to perform any of the steps of the method shown in FIG. 6.

The method begins at step 602 when the network node communicates with another network node to configure a selected gap configuration. The selected gap configuration is selected to facilitate maintaining a first connection between a user equipment and a first network associated with a first subscriber identity of the user equipment while the user equipment performs actions on a second network associated with a second subscriber identity of the user equipment. Further examples of steps that may be performed by the network node are described herein.

FIG. 7 illustrates another example method 700 performed by a network node, according to certain embodiments. Examples of a network node are described above (such as the gNB-CU, gNB-DU, MN, or SN described with respect to FIGS. 1-3) and below (such as network node 910 of FIG. 9, network node 1100 of FIG. 11, or network node 604 of FIG. 14). For example, in certain embodiments, the network node is operating as a CU and comprises processing circuitry configured to perform any of the steps of the method shown in FIG. 7. Where the network node operating as the CU is called a first network node, the network node operating as the DU may be called a second network node. Such terminology is provided for clarity purposes only.

The method begins at step 702 when the first network node operating as the CU determines at least one selected gap configuration by the first network node operating as the CU. At step 704, the first network node operating as the CU sends, to a second network node operating as a DU, the at least one selected gap configuration. The at least one selected gap configuration is selected for maintaining a first connection between a UE and a first network associated with a first subscriber identity of the UE while the UE performs actions on a second network associated with a second subscriber identity of the UE.

In a particular embodiment, the first network node receives at least one preferred gap configuration from the UE and communicates with the second network node to configure the selected gap configuration in response to receiving the at least one preferred gap configuration from the UE.

In a particular embodiment, when receiving the at least one preferred gap configuration from the UE, the first network node receives a list of a plurality of preferred gap configurations from the UE. The first network node chooses, from the plurality of preferred gap configurations received from the UE, the at least one selected gap configuration to send to the second network node operating as the DU.

In a particular embodiment, the first network node chooses the at least one selected gap configuration from the plurality of preferred gap configurations received from the UE is based on a configuration and/or policy of the first network node operating as the CU.

In a particular embodiment, the at least one selected gap configuration chosen by the first network node operating as the CU is a single gap configuration.

In a further particular embodiment, the single gap configuration matches a preferred gap configuration in the list of preferred gap configurations from the UE.

In another further particular embodiment, the single gap configuration differs from a preferred gap configuration in the list of preferred gap configurations from the UE.

In a further particular embodiment, the first network node sends, to the second network node operating as the DU, an indication that the second network node is to use the single gap configuration chosen by the first network node operating as the CU.

In a particular embodiment, the first network node sends, to the second network node operating as the DU, an indication that the second network node is to further select a final preferred gap configuration from the at least one selected gap configuration received from the first network node operating as the CU.

In a further particular embodiment, the at least one selected gap configuration comprises a plurality of selected gap configurations chosen by the first network node.

In a further particular embodiment, the first network node receives, from the second network node operating as the DU, the final preferred gap configuration and sends the final preferred gap configuration to the UE.

In a particular embodiment, the first network node communicates the at least one selected gap configuration to the UE.

In a particular embodiment, the at least one selected gap configuration includes at least one selected MUSIM gap.

In a particular embodiment, the at least one selected gap configuration indicates at least one of the following: a gap length, a gap periodicity, a starting point, and an offset.

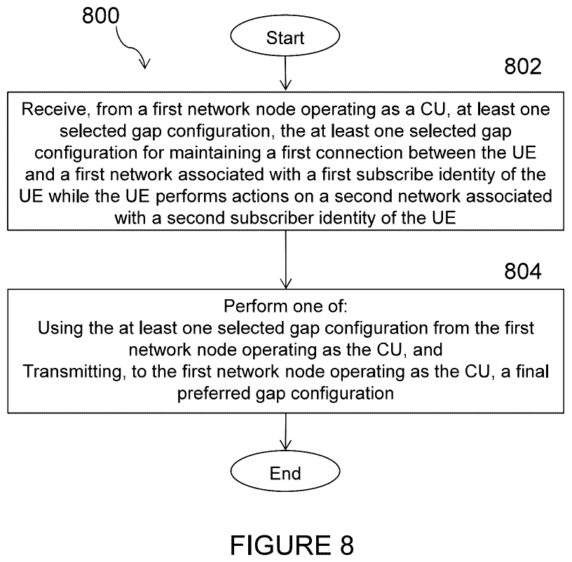

FIG. 8 illustrates another example method 800 performed by a network node, according to certain embodiments. Examples of a network node are described above (such as the gNB-CU, gNB-DU, MN, or SN described with respect to FIGS. 1-3) and below (such as network node 910 of FIG. 9, network node 1100 of FIG. 11, or network node 604 of FIG. 14). For example, in certain embodiments, the network node is operating as a DU and comprises processing circuitry configured to perform any of the steps of the method shown in FIG. 8. Where the network node operating as the CU is called a first network node, the network node operating as the DU may be called a second network node. Such terminology is provided for clarity purposes only.

The method begins at step 802 when the second network node operating as the DU receives, from a first network node operating as a CU, at least one selected gap configuration. The at least one selected gap configuration selected to facilitate and/or for maintaining a first connection between a UE and a first network associated with a first subscriber identity of the UE while the UE performs actions on a second network associated with a second subscriber identity of the UE.

At step 804, the second network node performs one of: using the at least one selected gap configuration from the first network node operating as the CU; and transmitting, to the first network node operating as the CU, a final preferred gap configuration.

In a particular embodiment, the second network node determines, based on a configuration and/or policy, whether the second network node operating as the DU accepts the at least one selected gap configuration from the first network node operating as the CU.

In a particular embodiment, the at least one selected gap configuration is used by the second network node operating as the DU when the second network node accepts the at least one selected gap configuration from the first network node operating as the CU. Alternatively, the final preferred gap configuration is transmitted to the first network node operating as the CU when the second network node determines not to accept the at least one selected gap configuration from the first network node.

In a particular embodiment, the at least one selected gap configuration from the first network node operating as the CU comprises at least one of: at least one preferred gap configuration of the UE, information indicating one or more supported gap configurations of the UE, and information indicating one or more supported gap configurations of the first network node operating as the CU.

In a particular embodiment, the at least one selected gap configuration is a single gap configuration.

In a further particular embodiment, the single gap configuration matches at least one preferred gap configuration of the UE.

In a further particular embodiment, the second network node receives, from the first network node operating as the CU, an indication that the second network node operating as the DU is to use the single gap configuration received from the first network node operating as the CU.

In a particular embodiment, the second network node receives, from the first network node operating as the CU, an indication that the second network node operating as the DU is to further select the final preferred gap configuration from the at least one selected gap configuration received from the first network node operating as the CU.

In a particular embodiment, the at least one selected gap configuration includes at least one selected Multiple Universal Subscriber Identity Module, MUSIM, gap.

In a particular embodiment, the at least one selected gap configuration indicates at least one of: a gap length, a gap periodicity, a starting point, or an offset.

Certain embodiments of the various examples may be implemented in the context of a standard, such as 3GPP TS 38.331, TS 38.472, TS 38.473, TS 48.423, and/or other suitable standard. Certain embodiments may be implemented in the context of Rel-17 MUSIM or a later release.

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3^{rd} Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

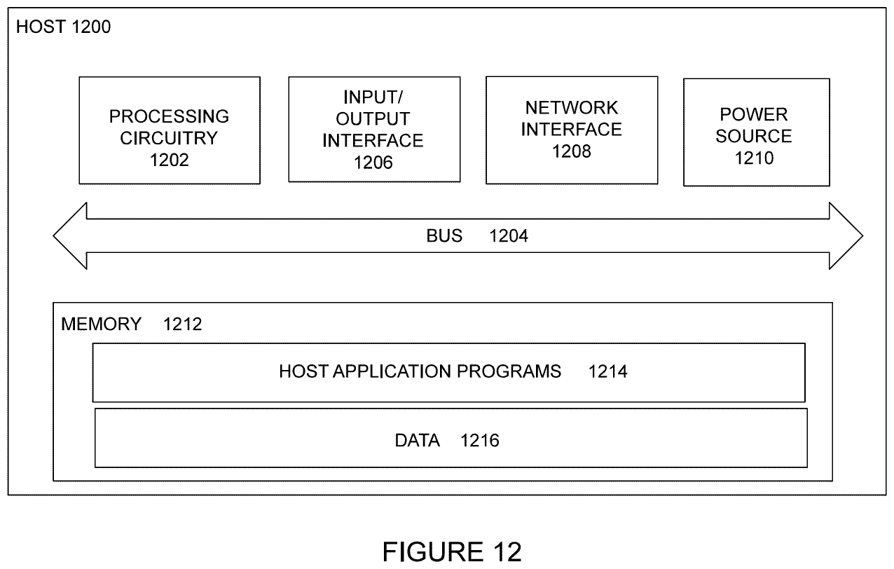

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

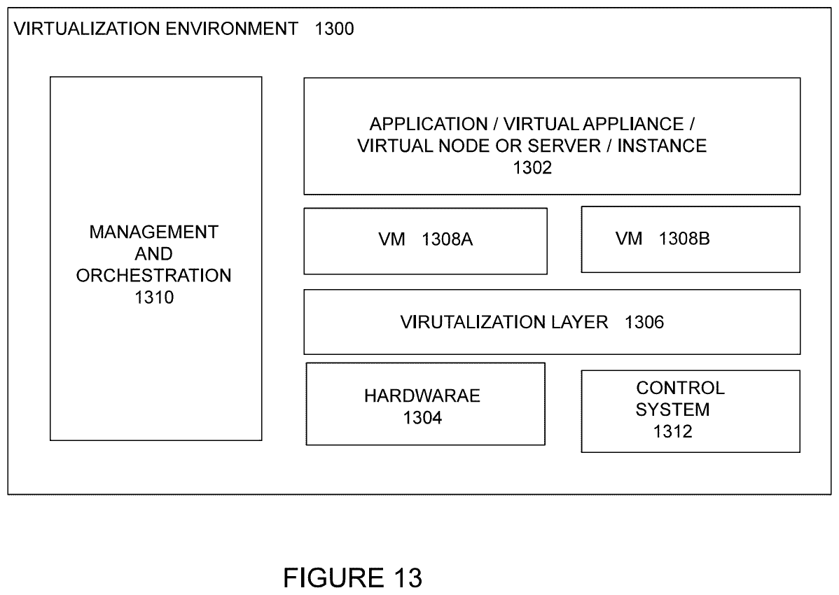

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, the teachings of these embodiments may improve the data rate, latency, or power consumption and thereby provide benefits such as reduced user waiting times, better responsiveness, or extended battery lifetime.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

### Group A Example Embodiments

Example Embodiment A1. A method performed by a user equipment, the method comprising: sending, to a network node, information indicating a preferred gap configuration of the user equipment; and receiving, from the network node, information indicating a selected gap configuration, the selected gap configuration selected to facilitate maintaining a first connection between the user equipment and a first network associated with a first subscriber identity of the user equipment while performing actions of the user equipment on a second network associated with a second subscriber identity of the user equipment.

Example Embodiment A2. The method of example embodiment A1, wherein the preferred gap configuration comprises a preferred Multiple Universal Subscriber Identity Modules (MUSIM) gap and the selected gap configuration comprises a final MUSIM gap.

Example Embodiment A3. The method of any of example embodiments A1-A2, wherein the selected gap configuration indicates at least one of the following: gap length, periodicity, starting point, or offset.

Example Embodiment A4. The method of any of example embodiments A1-A3, further comprising: determining the preferred gap configuration based on a configuration and/or a policy.

Example Embodiment A5. The method of any of example embodiments A1-A4, wherein the selected gap configuration matches the preferred gap configuration.

Example Embodiment A6. The method of any of example embodiments A1-A4, wherein the selected gap configuration differs from the preferred gap configuration.

Example Embodiment A7. The method of any of example embodiments A1-A6, wherein the selected gap configuration is determined by the network node.

Example Embodiment A8. The method of any of example embodiments A1-A6, wherein the selected gap configuration is determined by another network node and communicated to the user equipment via the network node to which the user equipment sent the information indicating the preferred gap configuration.

Example Embodiment A9. The method of any of example embodiments A1-A8, further comprising: using the selected gap configuration to maintain the first connection with the first network while performing actions on the second network.

Example Embodiment A10. The method of any of the previous embodiments, further comprising: providing user data; and forwarding the user data to a host via the transmission to the network node.

### Group B Example Embodiments

Example Embodiment B1. A method performed by a first network node, the method comprising: communicating with a second network node to configure a selected gap configuration, the selected gap configuration selected to facilitate maintaining a first connection between a user equipment and a first network associated with a first subscriber identity of the user equipment while the user equipment performs actions on a second network associated with a second subscriber identity of the user equipment.

Example Embodiment B2. The method of example embodiment B1, further comprising receiving a preferred gap configuration from the user equipment, wherein communicating with the second network node to configure the selected gap configuration is in response to receiving the preferred gap configuration.

Example Embodiment B3. The method of example embodiment B1, wherein communicating with the second network node to configure the selected gap configuration is in response to the first network node or the second network node triggering a renegotiation of the selected gap configuration.

Example Embodiment B4. The method of example embodiment B2, wherein triggering the renegotiation is in response to a change in scheduling conditions or requirements.

Example Embodiment B5. The method of any of example embodiments B1-B4, further comprising communicating the selected gap configuration to the user equipment.

Example Embodiment B6. The method of example embodiment B1, further comprising determining the selected gap configuration by the first network node, wherein communicating with the second network node to configure the selected gap configuration comprises sending the selected gap configuration to the second network node.

Example Embodiment B7. The method of example embodiment B1, wherein communicating with the second network node to configure the selected gap configuration comprises sending the second network node a request for the second network node to determine the selected gap configuration.

Example Embodiment B8. The method of any of example embodiments B1-B7, further comprising: determining, based on a configuration or policy, whether the first network node or the second network node is to determine the selected gap configuration.

Example Embodiment B9. The method of any of example embodiments B1-B8, wherein communicating with the second network node to configure the selected gap configuration comprises sending the second network node one or more of the following: a preferred gap configuration of the user equipment, information indicating one or more supported gap configurations of the user equipment, and/or information indicating one or more supported gap configurations of the first network node.

Example Embodiment B10. The method of any of example embodiments B1-B9, wherein the selected gap configuration comprises a selected Multiple Universal Subscriber Identity Modules (MUSIM) gap.

Example Embodiment B11. The method of any of example embodiments B1-B10, wherein the selected gap configuration indicates at least one of the following: gap length, periodicity, starting point, or offset.

Example Embodiment B12. The method of any of example embodiments B1-B11, wherein the selected gap configuration matches a preferred gap configuration of the user equipment.

Example Embodiment B13. The method of any of example embodiments B1-B11, wherein the selected gap configuration differs from a preferred gap configuration of the user equipment.

Example Embodiment B14. The method of any of example embodiments B1-B13, wherein communicating with the second network node to configure the selected gap configuration comprises sending the second network node an indicator, wherein a configuration of the indicator indicates whether the second network node is to accept the selected gap configuration from the first network node or to determine the selected gap configuration at the second network node.

Example Embodiment B15. The method of any of example embodiments B1-B14, wherein the first network node comprises a Centralized Unit (gNB-CU) and the second network node comprises a Distributed Unit (gNB-DU).

Example Embodiment B16. The method of any of example embodiments B1-B14, wherein the first network node comprises master node (MN) and the second network node comprises a secondary node (SN).

Example Embodiment B17. The method of example embodiment B16, the MN configured to facilitate Dual Connectivity.

Example Embodiment B18. A method performed by a second network node, the method comprising: communicating with a first network node to configure a selected gap configuration, the selected gap configuration selected to facilitate maintaining a first connection between a user equipment and a first network associated with a first subscriber identity of the user equipment while the user equipment performs actions on a second network associated with a second subscriber identity of the user equipment.

Example Embodiment B19. The method of example embodiment B18, wherein communicating with the first network node to configure the selected gap configuration is initiated by the first network node based on the first network node receiving a preferred gap configuration from the user equipment.

Example Embodiment B20. The method of example embodiment B18, wherein communicating with the first network node to configure the selected gap configuration is in response to the first network node or the second network node triggering a renegotiation of the selected gap configuration.

Example Embodiment B21. The method of example embodiment B20, wherein triggering the renegotiation is in response to a change in scheduling conditions or requirements.

Example Embodiment B22. The method of any of example embodiments B18-B21, wherein communicating with the first network node to configure the selected gap configuration comprises receiving the selected gap configuration from the first network node.

Example Embodiment B23. The method of any of example embodiments B18-B21, wherein communicating with the first network node to configure the selected gap configuration comprises receiving, from the first network node, a request for the second network node to determine the selected gap configuration and, in response, sending the selected gap configuration to the first network node.

Example Embodiment B24. The method of embodiment B23, further comprising: determining the selected gap configuration based on a configuration and/or policy.

Example Embodiment B25. The method of any of example embodiments B18-B24, wherein communicating with the first network node to configure the selected gap configuration comprises receiving from the first network node one or more of the following: a preferred gap configuration of the user equipment, information indicating one or more supported gap configurations of the user equipment, and/or information indicating one or more supported gap configurations of the first network node.

Example Embodiment B26. The method of any of example embodiments B18-B25, wherein the selected gap configuration comprises a selected Multiple Universal Subscriber Identity Modules (MUSIM) gap.

Example Embodiment B27. The method of any of example embodiments B18-B26, wherein the selected gap configuration indicates at least one of the following: gap length, periodicity, starting point, or offset.

Example Embodiment B28. The method of any of example embodiments B18-B27, wherein the selected gap configuration matches a preferred gap configuration of the user equipment.

Example Embodiment B29. The method of any of example embodiments B18-B27, wherein the selected gap configuration differs from a preferred gap configuration of the user equipment.

Example Embodiment B30. The method of any of example embodiments B18-B29, wherein communicating with the first network node to configure the selected gap configuration comprises receiving from the first network node an indicator and determining, based on a configuration of the indicator, whether the second network node is to accept the selected gap configuration from the first network node or to determine the selected gap configuration at the second network node.

Example Embodiment B31. The method of any of example embodiments B18-B30, wherein the first network node comprises a Centralized Unit (gNB-CU) and the second network node comprises a Distributed Unit (gNB-DU).

Example Embodiment B32. The method of any of example embodiments B18-B30, wherein the first network node comprises master node (MN) and the second network node comprises a secondary node (SN).

Example Embodiment B33. The method of example embodiment B32, the SN configured to facilitate Dual Connectivity.

Example Embodiment B34. The method of any of the previous embodiments, further comprising: using the selected gap configuration to facilitate maintaining the first connection between the user equipment and the first network while the user equipment performs actions on the second network.

Example Embodiment B35. The method of any of the previous embodiments, further comprising: obtaining user data; and forwarding the user data to a host or a user equipment.

### Group C Embodiments

Example Embodiment C1. A user equipment, comprising: processing circuitry configured to perform any of the steps of any of the Group A embodiments; and power supply circuitry configured to supply power to the processing circuitry.

Example Embodiment C2. A network node, the network node comprising: processing circuitry configured to perform any of the steps of any of the Group B embodiments; power supply circuitry configured to supply power to the processing circuitry.

Example Embodiment C3. A user equipment (UE), the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment C4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Example Embodiment C5. The host of the previous embodiment, wherein the cellular network further includes a network node configured to communicate with the UE to transmit the user data to the UE from the host.

Example Embodiment C6. The host of the previous 2 embodiments, wherein: the processing circuitry of the host is configured to execute a host application, thereby providing the user data; and the host application is configured to interact with a client application executing on the UE, the client application being associated with the host application.

Example Embodiment C7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment C8. The method of the previous embodiment, further comprising: at the host, executing a host application associated with a client application executing on the UE to receive the user data from the UE.

Example Embodiment C9. The method of the previous embodiment, further comprising: at the host, transmitting input data to the client application executing on the UE, the input data being provided by executing the host application, wherein the user data is provided by the client application in response to the input data from the host application.

Example Embodiment C10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Example Embodiment C11. The host of the previous embodiment, wherein the cellular network further includes a network node configured to communicate with the UE to transmit the user data from the UE to the host.

Example Embodiment C12. The host of the previous 2 embodiments, wherein: the processing circuitry of the host is configured to execute a host application, thereby providing the user data; and the host application is configured to interact with a client application executing on the UE, the client application being associated with the host application.

Example Embodiment C13. A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Example Embodiment C14. The method of the previous embodiment, further comprising: at the host, executing a host application associated with a client application executing on the UE to receive the user data from the UE.

Example Embodiment C21. The method of the previous embodiment, further comprising: at the host, transmitting input data to the client application executing on the UE, the input data being provided by executing the host application, wherein the user data is provided by the client application in response to the input data from the host application.

Example Embodiment C15. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Example Embodiment C16. The host of the previous embodiment, wherein: the processing circuitry of the host is configured to execute a host application that provides the user data; and the UE comprises processing circuitry configured to execute a client application associated with the host application to receive the transmission of user data from the host.

Example Embodiment C17. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Example Embodiment C18. The method of the previous embodiment, further comprising, at the network node, transmitting the user data provided by the host for the UE.

Example Embodiment C19. The method of any of the previous 2 embodiments, wherein the user data is provided at the host by executing a host application that interacts with a client application executing on the UE, the client application being associated with the host application.

Example Embodiment C20. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Example Embodiment C21. The communication system of the previous embodiment, further comprising: the network node; and/or the user equipment.

Example Embodiment C22. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Example Embodiment C23. The host of the previous 2 embodiments, wherein: the processing circuitry of the host is configured to execute a host application, thereby providing the user data; and the host application is configured to interact with a client application executing on the UE, the client application being associated with the host application.

Example Embodiment C24. The host of the any of the previous 2 embodiments, wherein the initiating receipt of the user data comprises requesting the user data.

Example Embodiment C25. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Example Embodiment C26. The method of the previous embodiment, further comprising at the network node, transmitting the received user data to the host.

1. A method performed by a first network node operating as a Centralized Unit, CU, the method comprising:
determining at least one selected gap configuration by the first network node operating as the CU; and
sending, to a second network node operating as a Distributed Unit, DU, the at least one selected gap configuration, the at least one selected gap configuration selected for maintaining a first connection between a user equipment, UE, and a first network associated with a first subscriber identity of the UE while the UE performs actions on a second network associated with a second subscriber identity of the UE.

2.-14. (canceled)

15. A method performed by a second network node operating as a Distributed Unit, DU, the method comprising:
receiving, from a first network node operating as a Centralized Unit, CU, at least one selected gap configuration, the at least one selected gap configuration selected for maintaining a first connection between a user equipment, UE, and a first network associated with a first subscriber identity of the UE while the UE performs actions on a second network associated with a second subscriber identity of the UE; and
performing one of:
using the at least one selected gap configuration from the first network node operating as the CU; and
transmitting, to the first network node operating as the CU, a final preferred gap configuration.

16.-24. (canceled)

25. A first network node operating as a Centralized Unit, CU, adapted to:
determine at least one selected gap configuration by the first network node operating as the CU; and
send, to a second network node operating as a Distributed Unit, DU, the at least one selected gap configuration, the at least one selected gap configuration selected for maintaining a first connection between a user equipment, UE, and a first network associated with a first subscriber identity of the UE while the UE performs actions on a second network associated with a second subscriber identity of the UE.

26. The first network node of claim 25, adapted to receive at least one preferred gap configuration from the UE, wherein the first network node is adapted to communicate with the second network node to configure the selected gap configuration in response to receiving the at least one preferred gap configuration from the UE.

27. The first network node of claim 26, wherein when receiving the at least one preferred gap configuration from the UE the first network node receives a list of a plurality of preferred gap configurations from the UE, and the first network node is adapted to:
choose, from the plurality of preferred gap configurations received from the UE, the at least one selected gap configuration to send to the second network node operating as the DU.

28. The first network node of claim 27, wherein choosing the at least one selected gap configuration from the plurality of preferred gap configurations received from the UE is based on a configuration and/or policy of the first network node operating as the CU.

29. The first network node claim 27, wherein the at least one selected gap configuration chosen by the first network node operating as the CU comprises a single gap configuration.

30. The first network node of claim 29, wherein the single gap configuration matches a preferred gap configuration in the list of preferred gap configurations from the UE.

31. The first network node of claim 29, wherein the single gap configuration differs from a preferred gap configuration in the list of preferred gap configurations from the UE.

32. The first network node of claim 29, wherein the first network node is adapted to send, to the second network node operating as the DU, an indication that the second network node is to use the single gap configuration chosen by the first network node operating as the CU.

33. The first network node of claim 26, wherein the first network node is adapted to send, to the second network node operating as the DU, an indication that the second network node is to further select a final preferred gap configuration from the at least one selected gap configuration received from the first network node operating as the CU.

34. The first network node of claim 33, wherein the at least one selected gap configuration comprises a plurality of selected gap configurations chosen by the first network node.

35. The first network node of claim 33, wherein the first network node is adapted to:
receive, from the second network node operating as the DU, the final preferred gap configuration; and
send the final preferred gap configuration to the UE.

36. The first network node of claim 25, wherein the first network node is adapted to communicate the at least one selected gap configuration to the UE.

37. The method of claim 25, wherein the at least one selected gap configuration comprises at least one selected Multiple Universal Subscriber Identity Module, MUSIM, gap.

38. The first network node of claim 25, wherein the at least one selected gap configuration indicates at least one of the following: a gap length, a gap periodicity, a starting point, and an offset.

39. A second network node operating as a Distributed Unit, DU, adapted to:
receive, from a first network node operating as a Centralized Unit, CU, at least one selected gap configuration, the at least one selected gap configuration selected for maintaining a first connection between a user equipment, UE, and a first network associated with a first subscriber identity of the UE while the UE performs actions on a second network associated with a second subscriber identity of the UE; and
perform one of:
using the at least one selected gap configuration from the first network node operating as the CU; and
transmitting, to the first network node operating as the CU, a final preferred gap configuration.

40. The second network node of claim 39, adapted to determine, based on a configuration and/or policy, whether the second network node operating as the DU accepts the at least one selected gap configuration from the first network node operating as the CU.

41. The second network node of claim 40, wherein:
the at least one selected gap configuration is used by the second network node operating as the DU when the second network node accepts the at least one selected gap configuration from the first network node operating as the CU, or
the final preferred gap configuration is transmitted to the first network node operating as the CU when the second network node determines not to accept the at least one selected gap configuration from the first network node.

42. The second network node of claim 39, wherein the at least one selected gap configuration from the first network node operating as the CU comprises at least one of:
at least one preferred gap configuration of the UE,
information indicating one or more supported gap configurations of the UE, and
information indicating one or more supported gap configurations of the first network node operating as the CU.

43. The second network node of claim 39, wherein the at least one selected gap configuration comprises a single gap configuration.

44. The second network node of claim 43, wherein the single gap configuration matches at least one preferred gap configuration of the UE.

45. The second network node of claim 43, adapted to receive, from the first network node operating as the CU, an indication that the second network node operating as the DU is to use the single gap configuration received from the first network node operating as the CU.

46. The second network node of claim 39, adapted to receive, from the first network node operating as the CU, an indication that the second network node operating as the DU is to further select the final preferred gap configuration from the at least one selected gap configuration received from the first network node operating as the CU.

47. The second network node of claim 39, wherein the at least one selected gap configuration comprises at least one selected Multiple Universal Subscriber Identity Module, MUSIM, gap.

48. The second network node of claim 39, wherein the at least one selected gap configuration indicates at least one of: a gap length, a gap periodicity, a starting point, or an offset.
